(19) United States
(12) Patent Application Publication
(10) Pub. No.: US 2026/0194154 A1
(43) Pub. Date: Jul. 9, 2026

(54) ARRANGEMENT FOR THE TRANSPORT OF MEDIA AND METHOD FOR PRODUCING AN ARRANGEMENT

(71) Applicant: TI Automotive Technology Center GmbH, Rastatt (DE)

(72) Inventors: Irfan KIZILAY, Reilingen (DE); Stefan Leipold, Seltz (FR); Manuel Lindow, Gernsbach (DE); Florian Deibel, Sinzheim (DE)

(21) Appl. No.: 19/443,518

(22) Filed: Jan. 8, 2026

(30) Foreign Application Priority Data
Jan. 8, 2025 (EP) 25150752.1

(51) Int. Cl. F16K 27/04; B29C 49/20; B29L 31/00

(52) U.S. Cl. CPC F16K 27/045; B29C 49/20; B29C 2049/2008; B29L 2031/7506

(57) ABSTRACT

An arrangement for the transport of media and a method for producing the arrangement, includes a base body configured as a blow-molded part with at least one inlet channel and at least one outlet channel. At least one functional element is connected to the base body in a form-fitting manner by forming the base body during blow molding, wherein the functional element has at least one inflow opening, which is connected to the inlet channel of the base body in a flow-conducting manner, and at least one outflow opening, which is connected to the outlet channel of the base body in a flow-conducting manner. The flow-conducting connections of the inflow opening and outflow opening are formed by the forming of the base body during the blow molding.

### RELATED APPLICATIONS

The present disclosure claims priority to and the benefit of European Application 25150752.1, filed on January 8, 2025, the entire contents of each of which are incorporated herein by reference.

### FIELD

The present disclosure relates to an arrangement for the transport of media having a base body configured as a blow-molded part and at least one functional element which is fixed to the base body. The present disclosure also relates to a method for producing an arrangement for the transport of media.

### BACKGROUND

Arrangements for the transport of media are needed, for example, in electromobility. Batteries in electric vehicles, especially lithium-ion batteries, are actively cooled or heated depending on the ambient temperature, for example, as they only achieve optimum performance within a defined temperature range. Therefore, the drive unit of an electric vehicle generally has a temperature control circuit with a pipe arrangement through which e.g., temperature control media are fed to the cells of the battery in order to control their temperature within a required temperature spectrum.

Other components of the drive unit of electric vehicles, such as the power electronics, the electric motor, the charging electronics and the corresponding plug connections and cables, can also be temperature-controlled, in particular cooled, in this way, which is particularly important in connection with fast charging processes.

Other vehicle electronics, in particular sensors and on-board computers, also require appropriate cooling. If a vehicle is equipped for autonomous driving, powerful sensors and powerful computers are required, wherein the systems are mostly redundantly present. Due to the limited installation space in the vehicles, these systems also have special requirements regarding a temperature control device to control the temperature of these components.

In addition, air conditioning systems are used to control the temperature of vehicle interiors, in which temperature control media are circulated in a complex pipe arrangement between the individual units of the air conditioning system. Further components are integrated into such a pipe arrangement, for example functional elements, pumps, valves, sensors or the like, making the pipe arrangement a comparatively complex structure that has to be integrated in a space-saving manner, particularly in mobile air conditioning systems. Another area of application is the temperature control of stationary energy storage devices.

The increasing complexity of such systems places ever new demands on the design of arrangements for the transport of media, which is why continuous improvement of the integration of functional elements, constant optimization of flow guides and the reduction of the assembly effort of such arrangements are required.

### BRIEF SUMMARY

The present disclosure provides an arrangement for the transport of media and a method for producing an arrangement for the transport of media, which can be manufactured simply and inexpensively.

The arrangement according to the present disclosure for the transport of media comprises a base body configured as a blow-molded part, which has at least one inlet channel and at least one outlet channel and at least one functional element, wherein the functional element is connected to the base body in a form-fitting manner by forming the base body during blow molding, wherein the functional element has at least one inflow opening and one outflow opening, wherein the inflow opening is connected in a flow-conducting manner to the inlet channel of the base body and the outflow opening is connected in a flow-conducting manner to the outlet channel of the base body, wherein the flow-conducting connections of the inflow opening and outflow opening are formed by forming the base body during blow molding.

The form-fit connection between the base body and the functional element means that they are firmly connected to each other in a media-tight manner. In particular, it is not necessary to provide additional sealing elements between the base body and the functional element. As the functional element has both the inflow opening and the outflow opening, a compact design of the arrangement can be achieved which allows media to be introduced into the inlet channel via the inflow opening and media to be discharged from the outlet channel via the outflow opening or vice versa. Due to the fact that the flow-conducting connections between the inflow opening and the inlet channel and between the outflow opening and the outlet channel are formed by forming the base body during blow molding, a simple and inexpensive production of the arrangement is achieved, which enables such a discharge of media from the arrangement as well as the introduction of media into the arrangement.

An advantageous embodiment of the arrangement can provide for the inlet channel and the outlet channel to be designed as separate flow channels. In this way, the inlet and outlet channels can form two separate flow regions in the base body, e.g., in order to be able to discharge a medium from the outlet channel and reintroduce it into the inlet channel or to transport different media through the inlet channel and the outlet channel. If the inlet channel and the outlet channel are designed as separate flow channels, the medium in the inlet channel, for example, can be transported at a different pressure and/or temperature level than in the outlet channel. For example, if the arrangement forms a section of a cooling or refrigerant circuit of an air conditioning system, a coolant or refrigerant can be discharged from the outlet channel to be fed to a component of the air conditioning system and then reintroduced into the inlet channel at a different pressure and/or temperature level.

Preferably, the inlet channel and the outlet channel can be formed by forming the base body during blow molding. For this purpose, the base body can comprise a material or be formed by a material that has a melting temperature that lies within a temperature range required for blow molding a preform. In particular, the melting temperature can be selected in such a way that softening and plastic deformability of the preform are possible, but deformation or even melting of the functional element is prevented.

A further advantageous embodiment of the arrangement can provide that the functional element has a coupling device by means of which a housing component can be coupled to the functional element in such a way that the inflow opening and outflow opening are connected in a flow-conducting manner. In particular, the housing component can be designed to accommodate a valve, a pump, a sensor or a cooler. For example, the housing component can form a receiving space in which the valve, pump, sensor or cooler can be arranged and connected to the inflow opening and outflow opening in a flow-conducting manner.

The receiving space formed by the housing component can be designed to be fluid-tight to an outer side of the arrangement. By coupling such a housing component with the functional element, the medium can be directed out of the outlet channel into the housing component via the outflow opening in order to be fed to the valve, pump, sensor or cooler, and directed back into the inlet channel via the inflow opening. A housing component can be coupled to the functional element via the coupling device, which enables the compact integration of various components, in particular the valve, the pump, the sensor or the cooler, into the arrangement. The coupling device can be formed by any form-fit and/or force-fit connection for coupling the housing component. For example, the coupling device can be designed as a screw, rivet, snap-in, clip, welded or adhesive connection or any connecting device designed in a different way.

In a further development of the arrangement, the coupling device can have at least one sealing element encompassing the inflow opening and/or at least one sealing element encompassing the outflow opening, wherein in a coupling configuration of the functional element with the housing component, an inflow-side flow region and an outflow-side flow region can be sealed off from one another. In particular, the sealing elements can be designed as ring-shaped sealing elements surrounding the opening, for example in the form of O-rings. Preferably, the sealing elements are formed of an elastomeric material, for example a rubber material or a thermoplastic elastomer. In addition to sealing the inflow-side flow region to the outflow-side flow region, the sealing elements can also be provided to form a seal to the outer side of the arrangement.

According to an advantageous design of the arrangement, the coupling device can have at least one centering device for mounting the housing component. This centering device can be designed as one or more shoulders, recesses, projections, pins or the like, for example. In particular, the centering device is designed as a shoulder that is formed at least in sections on the outer circumference of the functional element. In particular, the centering device is designed to correspond to the housing component or to a corresponding centering device on the housing component. The centering device enables simple and precise mounting of the housing component on the functional element as well as fluid-tight coupling.

Moreover, a further design of the arrangement can provide for the functional element to be formed by an essentially shell-shaped base element. The base element can have any geometric base area and/or cross-sectional geometry. Preferably, the base element is designed to be free of undercuts so that it can be easily produced by injection molding, for example. Preferably, the functional element can have a shell-shaped, plate-shaped, disk-shaped, in particular circular or oval, base area in a plan view. The functional element can also form an angular or free-form base in a plan view. Preferably, the functional element is formed of a polymer material, for example a thermoplastic polymer. In particular, the material of the functional element is selected in such a way that the functional element is dimensionally stable during blow molding. Advantageously, the melting temperature of the plastic selected for the functional element is therefore above a temperature required for blow molding the preform to form the base body. Alternatively, the functional element can also be formed of a metallic material.

Advantageously, it can be provided with the arrangement that the functional element has at least one sealing contour by means of which the functional element is connected to the base body in a materially bonded manner and the inlet channel is sealed off from the outlet channel, and/or has at least one sealing contour by means of which the functional element is connected to the base body in a materially bonded manner and the inlet channel and/or the outlet channel are sealed off from an outer side. Such a sealing contour can be used to form a materially bonded connection between the functional element and the base body during blow molding. In particular, the melting temperatures of the material of the sealing contour and the preform or base body can be matched accordingly so that they form the materially bonded connection during blow molding. Either the sealing contour can consist of a material that has a lower melting temperature than the material of the base body, or the base body can consist of a material that has a lower melting temperature than the material of the sealing contour. The sealing contour on the functional element and the base body can also consist of a material that has approximately the same melting temperature.

According to an advantageous embodiment of the arrangement, the functional element can form a receiving space, and the receiving space can form a flow-conducting connection between the inflow opening and the outflow opening. Such a receiving space can be provided in particular to accommodate a valve, a pump, a sensor or a cooler. Preferably, the receiving space can have an access opening in order to insert the valve, pump, sensor or cooler into it. The receiving space can, for example, be sealable in a fluid-tight manner by a cover element. If the valve, pump, sensor or cooler is arranged in the receiving space, it is connected to the inflow opening and the outflow opening in a flow-conducting manner. In other words, the valve, pump, sensor or cooler can form a flow-conducting connection between the inflow opening and the outflow opening.

Moreover, a further development of the arrangement can provide that the functional element has an inlet connection piece associated with the inflow opening and/or an outlet connection piece associated with the outflow opening, wherein the inlet connection piece opens into the inlet channel and/or the outlet connection piece opens into the outlet channel of the base body. Preferably, an end section of the inlet connection piece and/or the outlet connection piece can extend at least in sections into the inlet channel or the outlet channel. The outer diameter of the inlet connection piece and/or the outlet connection piece can be designed smaller than the inner diameter of the inlet channel and/or the outlet channel. A sealing contour can be provided on the end section of the inlet connection piece and/or the outlet connection piece in order to form a materially bonded and/or form-fit connection between the inlet connection piece and/or outlet connection piece and the base body during blow molding. This enables a secure and fluid-tight integration of the functional element with the base body.

According to an advantageous design of the arrangement, it can also be provided that the inflow opening is formed in a bottom section of the functional element and/or the outflow opening is formed in a side wall section of the functional element.

Preferably, the inlet connection piece can extend from the inlet opening formed in the bottom section as a deflection and be guided away laterally from the functional element. In other words, the inlet connection piece is designed as a lateral deflection on the bottom section of the functional element. Preferably, the outlet connection piece can extend laterally away from the functional element from the outflow opening formed in the side wall section. Preferably, it can be provided that the inflow opening, and the outflow opening are designed to point in different directions on the functional element. The inlet connection piece and the outlet connection piece can be provided on the functional element pointing in opposite directions or in different directions.

In a further development of the arrangement, the functional element can be completely encased by the base body by forming the base body during blow molding. In this way, a complete integration of the functional element into the base body can be provided, whereby a particularly fluid-tight seal to an outer side of the arrangement can be achieved. The functional element can be completely encased by the base body both by the receiving space formed by the functional element and by the housing component mounted on the functional element. In particular, it can be provided that the valve, the pump, the sensor or the cooler are arranged in the housing or the housing component. By encasing the functional element in the base body, an integrated or encapsulated arrangement can be formed, which can make maintenance-free operation possible.

In the method according to the present disclosure for producing an arrangement for the transport of media, in particular an arrangement according to one of the embodiments described above, at least one functional element and a preform consisting of polymeric material are first provided and arranged in a blow mold, wherein a base body is formed from the preform and the preform comes to rest against the functional element during the molding process to produce a connection, wherein a flow-conducting connection is formed between an inflow opening of the functional element and an inlet channel of the base body and between an outflow opening of the functional element and an outlet channel of the base body during the molding process of the preform.

Such a method can preferably be used to form both a form-fit connection between the base body and the functional element and the flow-conducting connection between the inflow opening and the inlet channel and between the outflow opening and the outlet channel in just one process step of the blow molding method. In particular, an additional process step of reworking the base body can be omitted, in particular a removal of excess material from the base body in the region of the inflow and/or outflow opening. In this way, a quick and cost-optimized production of the arrangement can be achieved. For this purpose, an opening section corresponding to the functional element can be introduced into the preform before blow molding.

A further development of the method can provide for the preform to be deformed during the molding process in such a way that the inlet channel and the outlet channel are formed as separate flow channels of the base body.

Preferably, the preform can have a tubular initial shape, in particular with only one continuous interior space, wherein the base body is formed with the inlet channel and the outlet channel as separate flow channels by blow molding from such a preform and the inlet channel and outlet channel are connected to the inflow opening and the outflow opening in a flow-conducting manner. The melting temperatures of the material of the preform and the material of the functional element can preferably be selected in such a way that softening of the preform is possible for blow molding and a melt bed is formed between the preform and the functional element, in which the preform or the base body and the functional element connect with each other, so that the base body and functional element are connected to each other in a materially bonded manner after hardening. At the same time, the material of the functional element should be selected such that it can withstand the temperature during blow molding without losing its shape.

In an advantageous embodiment of the method, a valve, a pump, a sensor or a cooler can be arranged in a receiving space formed by the functional element and the inflow opening and the outflow opening can be connected in a flow-conducting manner. Alternatively, or additionally, a housing component, in particular with a valve, a pump, a sensor or a cooler, can be coupled to the functional element in such a way that the inflow opening and the outflow opening are connected in a flow-conducting manner. In particular, the valve can be a rotary valve or a drum valve. Such valves are particularly suitable for integration into an arrangement for the transport of media. Furthermore, rotary valves are inexpensive to manufacture and allow several fluid channels to be controlled simultaneously.

In particular, the valve, the pump, the sensor or the cooler is arranged in the receiving space and/or the housing component before blow molding and forms the flow-conducting connection between the inflow opening and outflow opening or is connected to a flow-conducting connection between the inflow opening and outflow opening. Subsequently, the blow molding of the preform connects the inflow opening to the inlet channel and the outflow opening to the outlet channel, forming the flow-conducting connection between the outlet channel and the inlet channel via the valve, the pump, the sensor or the cooler.

Furthermore, a further embodiment of the method can provide that the functional element, in particular with the receiving space and/or with the coupled housing component, is completely encased by the preform during the molding process.

By encasing the functional element in this way, in particular by the receiving space and/or by the coupled housing component, an arrangement is formed in which the functional element, preferably with the pump, the valve, the sensor or the cooler, is completely surrounded by the base body, whereby an encapsulated, particularly fluid-tight seal to an outer side of the arrangement is formed in a simple and cost-optimized manner.

### BRIEF DESCRIPTION OF THE DRAWINGS

Some embodiments of the device according to the present disclosure, the use and the method are explained in more detail below with reference to the figures. These show, each schematically:

FIG. 1 a schematic sectional view of a first embodiment of an arrangement for the transport of media according to the disclosure;

FIG. 2 a schematic sectional view of a second embodiment of an arrangement for the transport of media according to the disclosure, with the outer circumferential section indicated in the drawing;

FIG. 3 in detail the base body with a part of the functional element of the embodiment according to FIG. 2.

### DETAILED DESCRIPTION

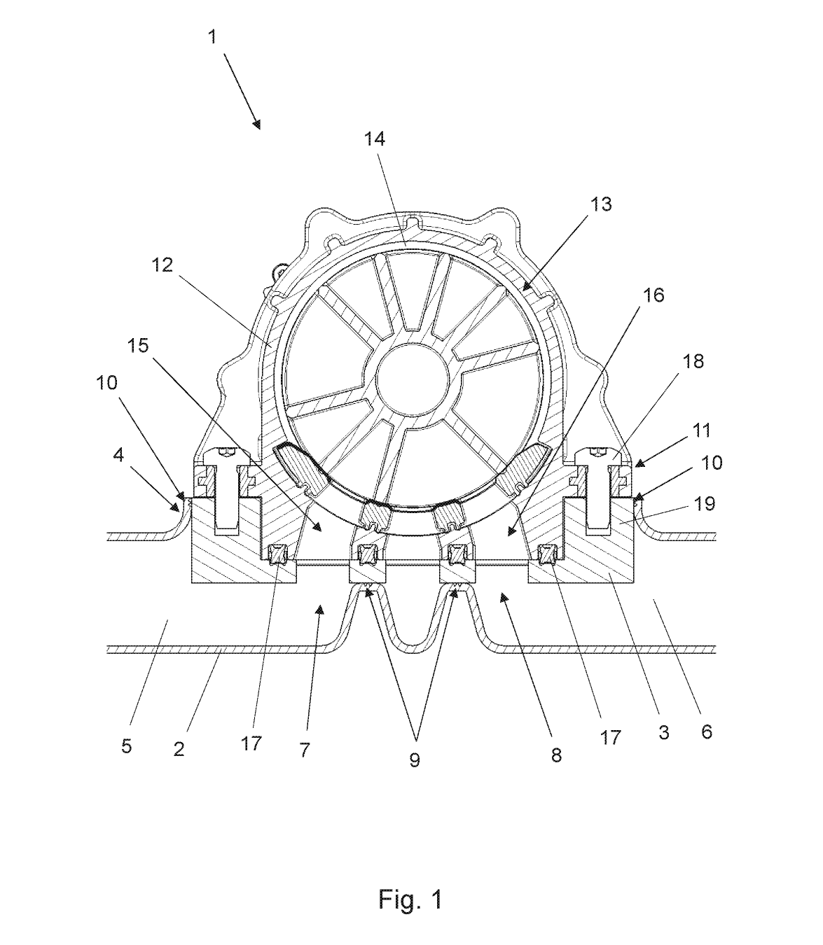

FIG. 1 shows a first embodiment of an arrangement 1 for the transport of media according to the present disclosure, wherein FIG. 1 is a schematic sectional view of the arrangement 1. Such an arrangement 1 forms a distribution structure which is used, for example, as part of a temperature control circuit that is used in an electric vehicle not shown in detail. Temperature control media, e.g., coolant in the form of cooling water, or other media can be distributed via the arrangement 1 and directed to the components of the electric vehicle to be temperature-controlled or other components, for example the batteries, the electric motors, the power electronics or the heat exchangers of the passenger compartment temperature control system. In another embodiment according to the present disclosure, the arrangement 1 is part of the temperature control of a stationary energy storage device.

The arrangement 1 comprises a base body 2 designed as a blow-molded part and a functional element 3, which is connected to the base body 2 in a form-fitting manner. The base body 2 and the functional element 3 are formed of a plastic material, for example polypropylene, polyamide or polyethylene. The base body 2 and the functional element 3 can also be formed of other materials.

The base body 2 is formed of a plastic whose melting temperature is suitable for the blow molding process and is below the melting temperature of the plastic selected for the functional element 3.

Preferably, the functional element 3 is formed of an injection-moldable plastic whose melting temperature is selected in such a way that the functional element 3 remains dimensionally stable during blow molding.

The functional element 3 is fixed to the base body 2 in a form-fitting and materially bonded manner, wherein the form-fit connection between the base body 2 and the functional element 3 is formed by forming a preform into the base body 2 during blow molding. For this purpose, the preform is placed together with the functional element 3 in a blow molding tool, wherein the preform comes to rest against the functional element 3 during blow molding, in particular against an outer circumferential section 4 of the functional element 3, and the form-fit connection is formed.

During blow molding, the preform is formed in such a way that the base body 2 forms an inlet channel 5 and an outlet channel 6. The inlet channel

5 and the outlet channel 6 form separate flow channels of the arrangement 1.

The functional element 3 is formed by an essentially shell-shaped base element, which can have any geometric design. According to the embodiment depicted in FIG. 1, the functional element 3 has a disk-shaped geometry. In contrast to such a disk-shaped geometry, the functional element 3 can also have an oval, angular or free-form geometry.

An inflow opening 7 and an outflow opening 8 are formed in the functional element 3. Similarly, two or more inflow openings 7 and/or two or more outflow openings 8 can be formed in the functional element 3. The inflow opening 7 and outflow opening 8 form passages in the functional element 3 and are provided as holes, for example.

The inflow opening 7 of the functional element 3 is connected to the inlet channel 5 of the base body 2 in a flow-conducting manner. The outflow opening 8 of the functional element 3 is connected to the outlet channel 6 of the base body 2 in a flow-conducting manner, wherein the flow-conducting connections between the inflow opening 7 and the inlet channel 5 and between the outflow opening 8 and the outlet channel 6 are each formed by forming the preform into the base body 2 during blow molding.

For this purpose, the preform is formed into the base body 2 in such a way that the inlet channel 5 is formed and connected to the inflow opening 7 in a flow-conducting manner and at the same time the outlet channel 6 is formed and connected to the outflow opening 8 in a flow-conducting manner. In other words, both the inlet channel 5 and outlet channel 6 as well as the flow-conducting connections between the inlet channel 5 and the inflow opening 7 and between the outlet channel 6 and the outflow opening 8 are formed in just one blow molding step.

Two first sealing contours 9 are formed on the functional element 3, through which the functional element 3 and the base body 2 are connected in a materially bonded manner and the inlet channel 5 and outlet channel 6 are sealed in a fluid-tight manner to each other. The sealing contours 9 have a triangular shape in cross-section. The material of the sealing contours 9 is selected in such a way that they melt at least partially during the blow molding process and the associated shaping of the base body 2 and the functional element 3 connects to the base body 2 in the region of the sealing contours 9 in a materially bonded and media-tight manner.

Moreover, two second sealing contours 10 are formed on the functional element 3, by means of which the functional element 3 and the base body 2 are connected to each other in a materially bonded and media-tight manner and the inlet channel 5 and outlet channel 6 are sealed in a fluid-tight manner to an outer side. The second sealing contours 10 extend all the way around the outer circumferential section 4 of the functional element 3 and are designed in the same way as the first sealing contours 9 to form the materially bonded connection between the functional element 3 and the base body 2.

A coupling device 11 is formed on the functional element 3, through which a housing component 12 is coupled to the functional element 3. The housing component 12 is any housing element that forms a receiving space 13 for accommodating a valve, a pump, a sensor or a cooler. In FIG. 1, the housing component 12 with a valve 14 arranged in the receiving space 13 is depicted by way of example. In the present embodiment, the valve 14 is designed as a rotary valve, which makes it possible to control many channels in a small space.

The housing component 12 connects the inflow opening 7 to the outflow opening 8 in a flow-conducting manner. The valve 14 is arranged in the flow-conducting connection between the inflow opening 7 and outflow opening 8. This creates an inflow-side flow region 15 and an outflow-side flow region 16.

Through the housing component 12 coupled to the functional element 3, a medium can be directed, via the outflow opening 8, from the outlet channel 6 into the housing component 12 and fed to the valve 14. The medium can then flow through the valve 14 and be introduced into the inlet channel 5 via the inflow opening 7. It is understood that a pump can also be arranged in the housing component 12, for example to generate a volume flow of the medium, a sensor can be arranged, for example to detect a sensor value, or a cooler can be arranged, for example to cool or heat the medium.

The inflow-side flow region 15 and the outflow-side flow region 16 are sealed in a fluid-tight manner to each other and to an outer side of the arrangement 1 by two sealing elements 17, for example in the form of O-rings, which encompass the inflow opening 7 and outflow opening 8.

In the depicted embodiment, the coupling device 11 is formed by a screw connection, so that the housing component 12 is screwed to the functional element 3 by several screws 18. Alternatively, the coupling device 11 can also be formed by a rivet, snap-in, clip, welded or adhesive connection or by any other type of connecting device.

The coupling device 11 also comprises a centering device 19, which is provided on the functional element 3 by a shoulder formed on the side of the outer circumference. The centering device 19 is designed to correspond to a recess provided on the housing component 12, so that the housing component 12 is mounted centered on the functional element 3 by engaging with the shoulder.

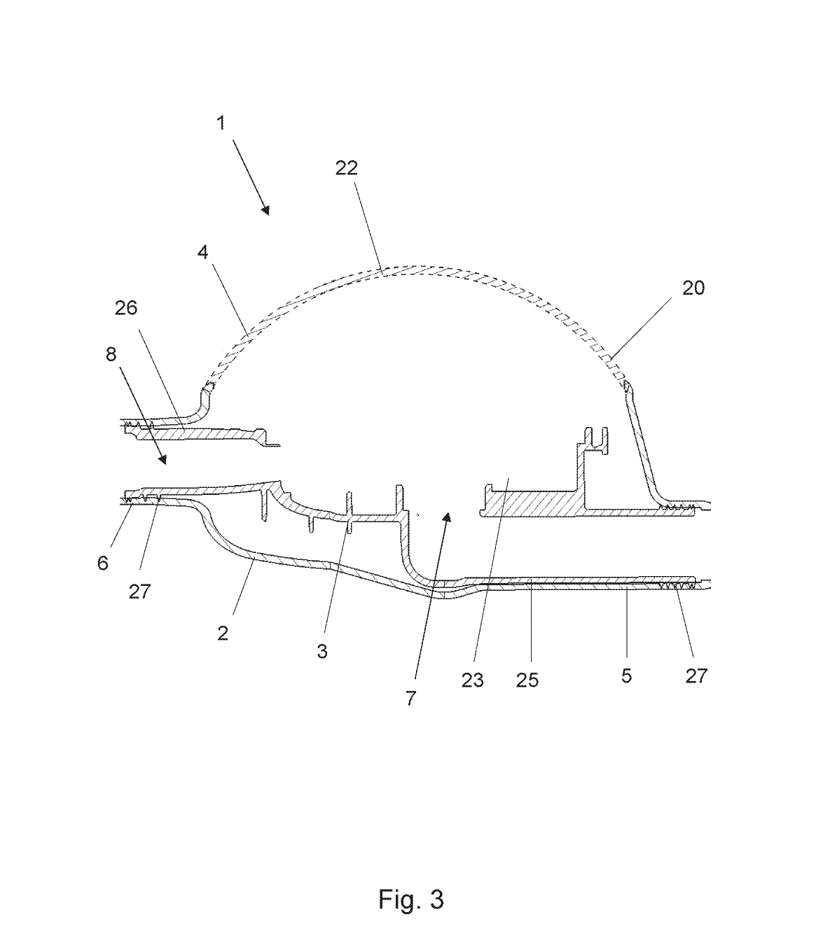

The dashed line depicted in FIG. 3 indicates an alternative or supplementary embodiment of the arrangement 1, in which the functional element 3 and the housing component 12 coupled to the functional element 3 are completely encased by a wall section 20 of the base body 2. In other words, the functional element 3 and the housing component 12 are arranged inside the base body 2 or encapsulated by the base body 2. This encasing of the functional element 3 and the housing component 12 is provided by forming the preform into the base body 2 during blow molding.

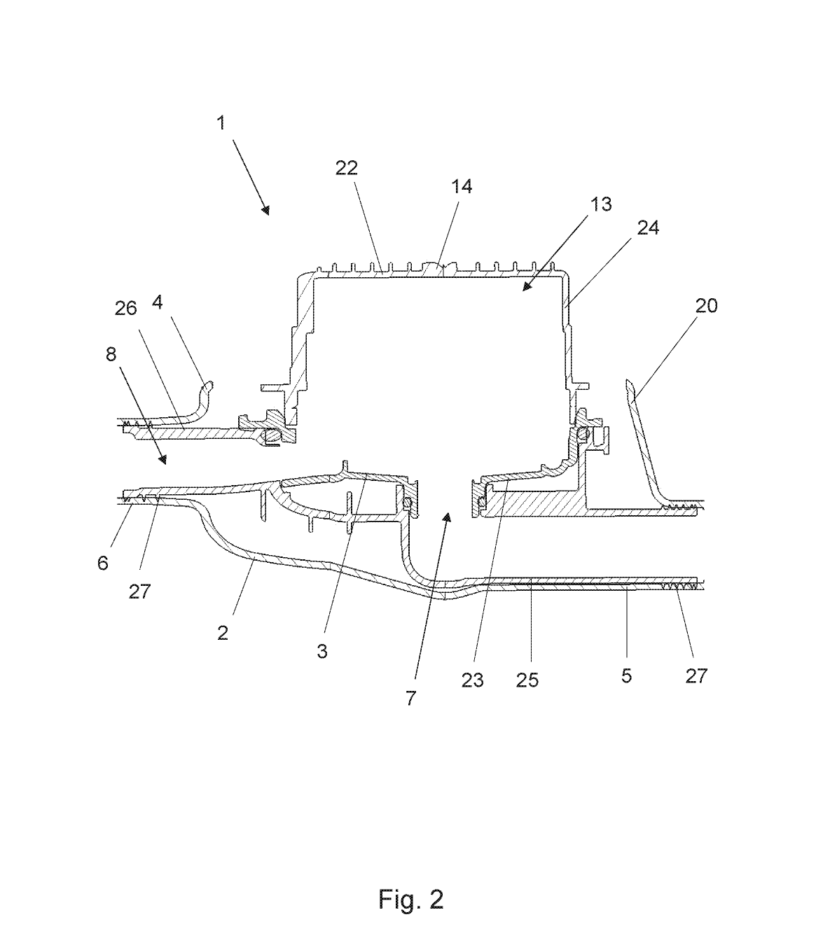

In FIG. 2 and 3, an alternative embodiment of an arrangement 1 for the transport of media according to the present disclosure is shown. FIG. 2 shows a schematic sectional view of the arrangement 1, wherein the base body 2 is broken open in the cover region in this representation and is therefore not shown completely. FIG. 3 shows a schematic sectional view of the arrangement 1 according to FIG. 2, wherein the functional element 3 is only partially depicted in this figure, but the base body 2 is shown in full.

According to this embodiment of the arrangement 1, the functional element 3 forms a receiving space 13 for accommodating the valve 14 not depicted in detail in FIG. 2 or for accommodating a pump, a sensor or a cooler.

Via an access opening, an access to the receiving space 13 is formed, in order to insert the valve, the pump, the sensor or the cooler into the receiving space 13. The receiving space 13 is sealed in a fluid-tight manner by a detachable cover element 22.

The inflow opening 7 and the outflow opening 8 are connected in a flow-conducting manner through the receiving space 13, wherein the valve 14 is arranged in the receiving space 13 in such a way that it forms the flow-conducting connection. The valve 14 is thus arranged in the receiving space 13 as a fluid connection between the inflow opening 7 and the outflow opening 8.

As can be seen in FIG. 2, the inflow opening 7 is formed in a bottom section 23 of the functional element 3. The bottom section 23 forms a bottom-side boundary of the receiving space 13. The outflow opening 8 is formed in a side wall section 24 of the functional element 3. The side wall section 24 forms a lateral boundary of the receiving space 13.

The inflow opening 7 is adjoined by an inlet connection piece 25 formed by the functional element 3, which extends from the bottom section 23 as a deflection to the side away from the functional element 3. The inlet connection piece 25 opens into the inlet channel 5, whereby the flow-conducting connection between the inlet channel 5 and the inflow opening 7 is formed in this embodiment of the arrangement 1.

The outflow opening 8 is adjoined by an outlet connection piece 26 formed by the functional element 3, which extends from the side wall section 24 laterally away from the functional element 3. The outlet connection piece 26 opens into the outlet channel 6, whereby the flow-conducting connection between the outlet channel 6 and the outflow opening 8 is formed.

As depicted in FIG. 2 and 3, the inlet connection piece 25 and the outlet connection piece 26 are designed to point in opposite directions on the functional element 3. Alternatively, it is also possible for these to be aligned at a different angle to each other, e.g., at an angle of 90°.

Sealing contours 27 are formed on the outer circumference side of the end sections of the inlet connection piece 25 and the outlet connection piece 26. During blow molding, the sealing contour 27 forms a materially bonded and media-tight connection between the functional element 3 and the base body 2.

According to an alternative or supplementary embodiment of the arrangement 1, it can be provided that the functional element 3 with the receiving space 13 formed by the functional element 3 is completely encased by a wall section 20 of the base body 2. As a result, the functional element 3 with the valve 14, which is not shown in detail and is accommodated in the receiving space 13, is arranged inside the base body 2 or encapsulated by it. As in the previous embodiment, the functional element 3 is encased by forming the preform into the base body 2 during blow molding.

1. An arrangement for the transport of media, comprising:
a base body which is configured as a blow-molded part and has at least one inlet channel and at least one outlet channel; and
at least one functional element, wherein the functional element is connected to the base body in a form-fitting manner by forming the base body during blow molding, wherein the functional element has at least one inflow opening and one outflow opening, wherein the inflow opening is connected in a flow-conducting manner to the inlet channel of the base body and the outflow opening is connected in a flow-conducting manner to the outlet channel of the base body,
wherein the flow-conducting connections of the inflow opening and outflow opening are formed by forming the base body during blow molding.

2. The arrangement according to claim 1, wherein the inlet channel and the outlet channel are formed as separate flow channels.

3. The arrangement according to claim 1, wherein the functional element has a coupling device by way of which a housing component for accommodating a valve, a pump, a sensor or a cooler can be coupled to the functional element such that the inflow opening and the outflow opening are connected in a flow-conducting manner.

4. The arrangement according to claim 3, wherein the coupling device has at least one sealing element encompassing the inflow opening and/or at least one sealing element encompassing the outflow opening, wherein, in a coupling configuration of the functional element with the housing component, an inflow-side flow region and an outflow-side flow region can be sealed to each other.

5. The arrangement according to claim 3, wherein the coupling device has at least one centering device for mounting the housing component.

6. The arrangement according to claim 1, wherein the functional element is formed by a substantially shell-shaped base element.

7. The arrangement according to claim 1, wherein the functional element has at least one sealing contour, by means of which the functional element is connected to the base body in a materially bonded manner and the inlet channel is sealed to the outlet channel, and/or has at least one sealing contour, by means of which the functional element is connected to the base body in a materially bonded manner and the inlet channel and/or the outlet channel are sealed to an outer side.

8. The arrangement according to claim 1, wherein the functional element forms a receiving space, in particular for accommodating a valve, a pump, a sensor or a cooler, and the receiving space forms a flow-conducting connection between the inflow opening and the outflow opening.

9. The arrangement according to claim 1, wherein the functional element has an inlet connection piece associated with the inflow opening and/or an outlet connection piece associated with the outflow opening, wherein the inlet connection piece opens into the inlet channel and/or the outlet connection piece opens into the outlet channel of the base body.

10. The arrangement according to claim 1, wherein the inflow opening is formed in a bottom section of the functional element and/or in that the outflow opening is formed in a side wall section of the functional element.

11. The arrangement according to claim 1, wherein the functional element is completely encased by the base body as a result of the forming of the base body during blow molding.

12. A method for producing the arrangement for the transport of media according to claim 1, in which at least one functional element and a preform consisting of polymeric material are provided and arranged in a blow mold, wherein a base body is formed from the preform and the preform comes to rest against the functional element during the molding process to produce a connection, and wherein a flow-conducting connection is formed between an inflow opening of the functional element and an inlet channel of the base body and between an outflow opening of the functional element and an outlet channel of the base body during the molding process of the preform.

13. The method according to claim 12, wherein the preform is deformed during the molding process in such a way that the inlet channel and the outlet channel are formed as separate flow channels of the base body.

14. The method according to claim 12, wherein a valve, a pump, a sensor or a cooler is arranged in a receiving space formed by the functional element, and the inflow opening and the outflow opening are brought into flow-conducting connection and/or a housing component, in particular with a valve, a pump, a sensor or a cooler, is coupled to the functional element in such a way that the inflow opening and the outflow opening are connected in a flow-conducting manner.

15. The method according to claim 14, wherein the functional element and the receiving space and/or the coupled housing component, is completely encased by the preform during the molding process.
